(19) United States
(12) Patent Application Publication
(10) Pub. No.: US 2006/0231963 A1
(43) Pub. Date: Oct. 19, 2006

(54) Method and apparatus for producing fine particles

(75) Inventors: Masahiro Ohshima, Shiga (JP); Kazuhiro Mae, Kyoto (JP); Iori Hashimoto, Kyoto (JP); Shinji Hasebe, Kyoto (JP); Osamu Okuma, Kyoto (JP); Takayuki Hirano, Kanagawa (JP)

Correspondence Address: C. IRVIN MCCLELLAND;OBLON, SPIVAK, MCCLELLAND, MAIER & NEUSTADT, P.C., 1940 DUKE STREET, ALEXANDRIA, VA, 22314, US

(73) Assignee: The New Industry Research Organization, Hyogo (JP)

(21) Appl. No.: 10/544,063

(22) PCT Filed: Dec. 2, 2003
(86) PCT No.: PCT/JP03/15374

§ 371 Date: May 25, 2006

(30) Foreign Application Priority Data
Feb. 3, 2003 (JP) 2003-25995
Jul. 14, 2003 (JP) 2003-274304

(51) Int. Cl. B01F 3/04

(52) U.S. Cl. 261/121.1

(57) ABSTRACT

A producing apparatus (1) of fine particles includes two pipes constructed by an outer pipe (11) and an inner pipe (21) arranged in a concentric shape. The tip (21a) of the inner pipe (21) is spaced from the tip (11b) of the outer pipe (11) by a comparatively long distance. Fluid II is flowed toward the tip (21a) of the inner pipe (21) within the inner pipe (21). Fluid I is flowed toward the tip of the outer pipe (11) as a continuous phase within the outer pipe (11). The flow velocities of the fluid I and the fluid II within the outer pipe (11) and the inner pipe (21) are set to appropriate values by controlling the operations of respective pumps (14, 24) by commands from a controller (31). Thus, the fluid II exhausted from the tip (21a) of the inner pipe (21) becomes a droplet (3) having a in approximately spherical shape surrounded by the fluid I within the outer pipe (11) and having a predetermined desirable diameter.

### TECHNICAL FIELD

The present invention relates to a method and an apparatus for producing fine particles in the microchemistry practically using the characteristics of a micro space of a micron order.

### BACKGROUND ART

In the microchemistry, gases or liquids are mixed, reacted, extracted, separated, purified, etc. by utilizing a phenomenon obtained by flowing the gases or the liquids to a micro flow path of several μm to several hundred μm. In recent years, the microchemistry practically using the characteristics of the micro space of the micron order is greatly noticed since operations of manufacture, reactions, etc. of substances unable to be realized in a macro scale can be greatly efficiently performed at high speed.

A micro emulsifier is described as one application example of such a microchemistry in JP-A-2002-346352 (patent document 1). This micro emulsifier has a silicon substrate in which a crossing portion of two slit holes respectively formed from both upper and lower faces is formed as an opening (see FIGS. 1 and 2). When a dispersion phase (e.g., oil) located on one face of the silicon substrate is pushed-out from the opening into a continuous phase (e.g., water) flowed along the other face by using this micro emulsifier, it is possible to purify an emulsion of about monodispersion in which the dispersion phase becomes a micro droplet (fine particle).

However, the micro emulsifier of the above patent document 1 has the problem that droplets of the dispersion phase are not sufficiently uniformly distributed within a continuous layer, and the producing speed of the droplets is comparatively slow and is not suitable for rapid production. Further, in the micro emulsifier of the patent document 1, the slit hole is formed by using an etching technique using photolithography. Therefore, the micro emulsifier has a great disadvantage since a very expensive dedicated device is required to manufacture this slit hole.

Therefore, a main object of the present invention is to provide a method and an apparatus for producing fine particles in which a mixture having the fine particles of about monodispersion of the dispersion phase sufficiently uniformly distributed within a continuous layer can be rapidly produced.

Further, another object of the present invention is to provide a producing apparatus in which fine particles are produced without using an etching technique utilizing photolithography.

### DISCLOSURE OF THE INVENTION

As a result of an earnest research, the present inventors have found that the dispersion phase (fluid II) is flowed to an inner pipe of two pipes, and the continuous phase (fluid I) is flowed to an outer pipe, and the fluid II exhausted from the inner pipe becomes fine particles of about monodispersion sufficiently uniformly distributed within the outer pipe and is produced in about the same period by suitably selecting flow velocities and physical property values of these fluids I and II, and the sizes of the inner pipe and the outer pipe. Moreover, the producing speed of the fine particles is comparatively fast since the two fluids I and II are flowed in the same direction.

Namely, at one view point, the present invention is a method for producing fine particles by using a first pipe for flowing fluid I therethrough, and a second pipe for flowing fluid II therethrough and arranged such that one end of the second pipe exists within the first pipe and the vicinity of the one end is extended substantially in parallel with the axial direction of the first pipe; wherein the fluid I and the fluid II are respectively flowed to the first and second pipes by selecting flow velocities and physical property values of the fluid I and the fluid II and the sizes of the first and second pipes satisfying the following formula (1) or (2) such that the fluid II exhausted from the one end of the second pipe becomes fine particles surrounded by the fluid I within the first pipe.

At another view point, the present invention is a producing apparatus of fine particles comprising:

a first pipe for flowing fluid I therethrough;

a second pipe for flowing fluid II therethrough and arranged such that one end of the second pipe exists within the first pipe and the vicinity of the one end is extended substantially in parallel with the axial direction of the first pipe; and

flow velocity control means for controlling the flow velocities of the fluid I and the fluid II on the basis of physical property values of the fluid I and the fluid II and the sizes of the first and second pipes such that the fluid II exhausted from the one end of the second pipe becomes fine particles surrounded by the fluid I within the first pipe;

wherein the flow velocity control means controls the flow velocities of the fluid I and the fluid II so as to satisfy the following formula (1) or (2).

$$\begin{matrix}{F}_{S} = {F}_{B} + {F}_{K} + {F}_{D} & ( 1 ) \\ {D}^{2} = {D}_{ii}^{2} + \frac{4 / π}{\frac{1}{2} {C}_{D} ρ {U}_{e}^{2}} [ π γ {D}_{ii} - {ρ}^{′} π \frac{{D}_{ii}^{2}}{4} {U}_{i}^{2} ] & ( 2 )\end{matrix}$$

where

F_{S}=πγDᵢᵢ—interfacial tension (N) between the fine particles and the second pipe,

$${F}_{B} = λ \frac{4}{3} {π ( \frac{D}{2} )}^{3} g Δ ρ$$

—buoyant force (N) of the fine particles,

F_{K}=ρ′UᵢQᵢ—inertial force (N) of the fluid II, and

$${F}_{D} = \frac{{C}_{D}}{2} ρ {U}_{e}^{2} \frac{π}{4} ( {D}^{2} - {D}_{ii}^{2} )$$

—fluid force (N) of the fluid I affecting the fine particles,

γ: interfacial tension coefficient (N/m),

g: acceleration of gravity,

λ: coefficient,

D: diameter (m) of the fine particle,

Δρ=ρ−ρ′ (ρ: density (kg/m³) of the fluid I, ρ′: density (kg/m³) of the fluid II),

Uᵢ: average flow velocity (m/s) of the fluid II,

Uₑ: average flow velocity (m/s) of the fluid I around the fine particles,

$${Q}_{i} = \frac{π}{4} {D}_{ii}^{2} {U}_{i} \text{:}$$

flow rate (m³/s) of the fluid II (Dᵢᵢ: inner diameter of the second pipe), and

C_{D}: flow resistance coefficient of the fine particles,

$${C}_{D} = \frac{κ}{Re} = \frac{κ}{{U}_{e} D {ρ}^{′}} μ$$

(Re: Reynolds number, κ: constant, μ: viscosity coefficient of the fluid I).

In accordance with this structure, for example, it is possible to rapidly produce a mixture such as an emulsion in which the fine particles of about monodispersion of the fluid II are sufficiently uniformly distributed within the fluid I. Therefore, the fine particles of high quality of a micro size can be industrially produced by applying the present invention. Further, in accordance with the present invention, there is also an advantage in that the fine particles of about monodispersion of the fluid II can be produced by not using a surfactant without causing attachment to the inner wall of the first pipe and blocking of the pipe. Further, the producing apparatus of the present invention has great advantages in that a pipe sold at a market is used as a main member and the producing apparatus can be manufactured by cheap equipment without using an etching technique utilizing photolithography.

In the present invention, fluid α may be also flowed into the first pipe at a region existing in the downstream direction from the one end of the second pipe. A physical stimulus may be also given to the fine particles of the fluid II flowed in the first pipe at a region existing in the downstream direction from the one end of the second pipe. Thus, a reaction can be generated in the fluid II, and super fine particles can be produced within the fine particles of the fluid II. In the reaction In this example, the reaction speed is very fast since the surface area of the fine particle with respect to its volume is large. Furthermore, since reactions are limited within the fine particles of very small sizes, the reactions unexecutable in the macro chemistry because of an explosively advancement can be generated. Thus, the fine particles produced in the present invention are very effective as a batch reactor of a micro size, and can be widely applied.

Further, the present invention can be also applied to a case in which three pipes are coaxially arranged. Namely, at another view point, the present invention is a method for producing fine particles by using a first pipe for flowing fluid I therethrough; a second pipe for flowing fluid II therethrough and arranged such that one end of the second pipe exists within the first pipe and the vicinity of the one end is extended substantially in parallel with the axial direction of the first pipe; and a third pipe for flowing fluid III therethrough and arranged such that one end of the third pipe exists within the second pipe and the vicinity of the one end of the third pipe is extended substantially in parallel with the axial direction of the second pipe;

wherein the fluid I, the fluid II and the fluid III are respectively flowed to the first, second and third pipes by selecting flow velocities and physical property values of the fluid I, the fluid II and the fluid III, and the sizes of the first, second and third pipes such that the fluid III exhausted from the one end of the third pipe becomes fine particles surrounded by the fluid II within the second pipe, and the fluid II exhausted from the one end of the second pipe becomes fine particles of a double structure surrounding one or more fine particles of the fluid III within the first pipe.

At another view point, the present invention is a producing apparatus of fine particles comprising:

a first pipe for flowing fluid I therethrough;

a second pipe for flowing fluid II therethrough and arranged such that one end of the second pipe exists within the first pipe and the vicinity of the one end is extended substantially in parallel with the axial direction of the first pipe;

a third pipe for flowing fluid III therethrough and arranged such that one end of the third pipe exists within the second pipe and the vicinity of the one end of the third pipe is extended substantially in parallel with the axial direction of the second pipe; and

flow velocity control means for controlling the flow velocities of the fluid I, the fluid II and the fluid III on the basis of physical property values of the fluid I, the fluid II and the fluid III, and the sizes of the first, second and third pipes such that the fluid III exhausted from the one end of the third pipe becomes fine particles surrounded by the fluid II within the second pipe, and the fluid II exhausted from the one end of the second pipe becomes fine particles of a double structure surrounding one or more fine particles of the fluid III within the first pipe.

Thus, it is possible to rapidly produce a mixture in which the fine particles (micro capsules) of about monodispersion of the double structure for closing the fluid III within the shell of the fluid II are sufficiently uniformly distributed. Thus, the present invention can be applied to various uses in the field of the micro chemistry.

In the present invention, fluid β may be also flowed in the first pipe at a region existing in the downstream direction from the one end of the second pipe. A physical stimulus may be also given to the fine particles of the fluid II flowed in the first pipe at a region existing in the downstream direction from the one end of the second pipe.

Further, the present invention can be also applied to a case in which four pipes or more are coaxially arranged. Namely, at still another view point, the present invention is a method for producing fine particles by using n-pipes (n: a natural number of 3 or more) coaxially arranged with respect to each other such that one end of an n-th pipe for flowing n-th fluid therethrough exists within an (n−1)-th pipe arranged outside the n-th pipe, and the vicinity of the one end of the n-th pipe is extended substantially in parallel with the axial direction of the (n−1)-th pipe;

wherein, when m is any value of natural numbers of n−2 or less, m-th, (m+1)-th and (m+2)-th fluids are respectively flowed to the m-th, (m+1)-th and (m+2)-th pipes by selecting flow velocities and physical property values of the m-th, (m+1)-th and (m+2)-th fluids and the sizes of the m-th, (m+1)-th and (m+2)-th pipes such that the fine particles of the (m+1)-th fluid surrounding one or more fine particles of the (m+2)-th fluid exhausted from one end of the (m+2)-th pipe are exhausted from one end of the m-th pipe.

At still another view point, the present invention is a producing apparatus of fine particles comprising:

n-pipes (n: a natural number of 3 or more) coaxially arranged with respect to each other such that one end of an n-th pipe for flowing n-th fluid therethrough exists within an (n−1)-th pipe arranged outside the n-th pipe, and the vicinity of the one end of the n-th pipe is extended substantially in parallel with the axial direction of the (n−1)-th pipe; and

flow velocity control means for controlling the flow velocities of m-th, (m+1)-th and (m+2)-th fluids when m is any value of natural numbers of n−2 or less, on the basis of physical property values of the m-th, (m+1)-th and (m+2)-th fluids and the sizes of the m-th, (m+1)-th and (m+2)-th pipes such that the fine particles of the (m+1)-th fluid surrounding one or more fine particles of the (m+2)-th fluid exhausted from one end of the (m+2)-th pipe are exhausted from one end of the m-th pipe.

Thus, it is possible to rapidly produce a mixture in which the fine particles (multilayer micro capsules) of about monodispersion in a multilayer shell structure are sufficiently uniformly distributed. Thus, the present invention can be applied to various uses in the field of the micro chemistry.

Even when the four pipes or more are coaxially arranged as in the present invention, another fluid may be also flowed into the first pipe at a region existing in the downstream direction from the one end of the second pipe. A physical stimulus may be also given to the fine particles of the fluid II flowed in the first pipe at a region existing in the downstream direction from the one end of the second pipe.

### BRIEF DESCRIPTION OF THE DRAWINGS

FIG. 1 is a view drawing the schematic construction of a producing apparatus of fine particles in accordance with a first embodiment of the present invention.

FIG. 2 is a schematic enlarged view of the vicinity of the tip of an inner pipe drawn in FIG. 1.

FIG. 3 is a view drawing the schematic construction of a producing apparatus of fine particles in accordance with a second embodiment of the present invention.

FIG. 4 is a view drawing the schematic construction of a producing apparatus of fine particles in accordance with a third embodiment of the present invention.

FIG. 5 is a view drawing the schematic construction of a producing apparatus of fine particles in accordance with a fourth embodiment of the present invention.

FIG. 6 is a view drawing the schematic construction of a producing apparatus of fine particles in accordance with a fifth embodiment of the present invention.

FIG. 7 is a view drawing the schematic construction of a producing apparatus of fine particles in accordance with a sixth embodiment of the present invention.

FIG. 8 is a view drawing the schematic construction of a producing apparatus of fine particles in accordance with a seventh embodiment of the present invention.

FIG. 9 is a view drawing the schematic construction of a producing apparatus of fine particles in accordance with an eighth embodiment of the present invention.

FIG. 10 is a graph drawing a relation of the flow velocities of fluids I and II and the producing period of a droplet in one embodiment of the present invention.

FIG. 11 is a graph drawing a relation of the flow velocities of the fluids I and II and the diameter of the produced droplet in one embodiment of the present invention.

### BEST MODE FOR CARRYING OUT THE INVENTION

The preferred embodiments of the present invention will next be explained with reference to the drawings.

### FIRST EMBODIMENT

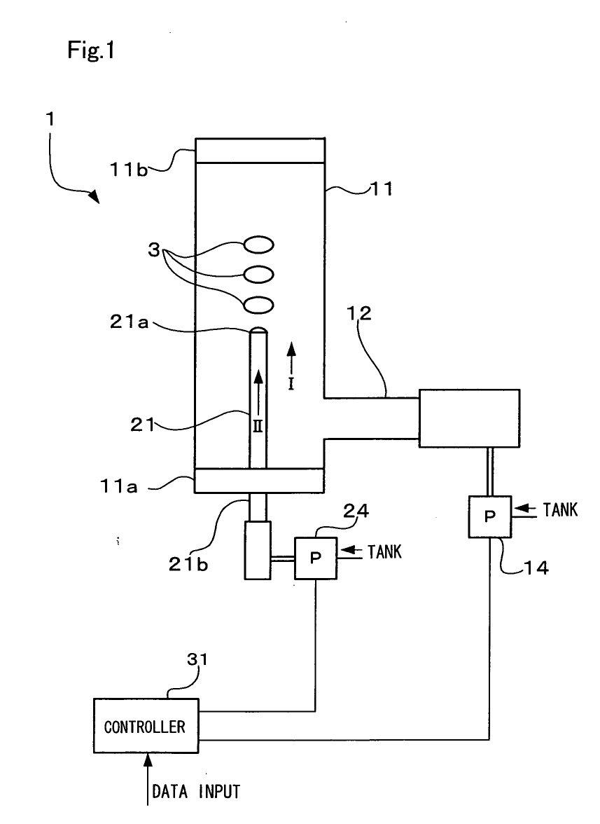

FIG. 1 is a view drawing the schematic construction of a producing apparatus of fine particles in accordance with a first embodiment of the present invention. As shown in FIG. 1, the producing apparatus 1 of fine particles in accordance with this embodiment includes two pipes constructed by an outer pipe (first pipe) 11 and an inner pipe (second pipe) 21. Both the outer pipe 11 and the inner pipe 21 are pipes of a circular shape in the section of a hollow portion and are arranged in a concentric shape. The inner pipe 21 is extended in the axial direction from a base end 11a of the outer pipe 11 to its tip 11b. The tip of the outer pipe 11 is connected to an unillustrated tank. The length of the inner pipe 21 within the outer pipe 11 is sufficiently shorter than the length of the outer pipe 11. The tip 21a of the inner pipe 21 is spaced from the tip 11b of the outer pipe 11 by a comparatively long distance. A pump 24 is connected to a base end 21b of the inner pipe 21. The pump 24 sends-out fluid (liquid or gas) (hereinafter called “fluid II”) within the unillustrated tank into the inner pipe 21 as a dispersion phase on the basis of commands from a controller 31.

A branch pipe 12 is connected to the vicinity (at least an upstream portion from the tip 21a of the inner pipe 21) of the base end 11a of the outer pipe 11. A pump 14 is connected to this branch pipe 12. The pump 14 sends-out fluid (liquid or gas) (hereinafter called “fluid I”) within the unillustrated tank into the outer pipe 11 as a continuous phase through the branch pipe 12 on the basis of commands from the controller 31.

In the producing apparatus 1 of fine particles, when both the outer pipe 11 and the inner pipe 21 are filled with the fluids I and II, the flow velocities of the fluids I and II within the outer pipe 11 and the inner pipe 21 are adjusted to appropriate values selected as described later by controlling the operations of the respective pumps 14, 24 by commands from the controller 31. Thus, the fluid II exhausted from the tip 21a of the inner pipe 21 can become a droplet 3 having a predetermined desirable diameter and a spherical shape surrounded by the fluid I within the outer pipe 11. The diameter of the droplet 3 becomes about the same with respect to any droplet 3. When the controller 31 selects the flow velocities of the fluid I and the fluid II, data relating to the sizes of the outer pipe 11 and the inner pipe 21 and data relating to physical property values of the fluid I and the fluid II are inputted from the exterior to the controller 31 in advance. If the flow velocities of the fluid I and the fluid II are constant, the droplet 3 is produced every predetermined period. The droplet 3 of the fluid II exhausted from the tip 21a of the inner pipe 21 is moved toward the tip 11b of the outer pipe 11. The fluid I dispersing the droplet 3 of the fluid II is guided to the tank to which the tip 11b of the outer pipe 11 is connected.

Thus, for example, it is possible to rapidly produce a mixture in which the droplet 3 of about monodispersion of the fluid II as fine particles of high quality of a micro size as in an emulsion are sufficiently uniformly distributed within the fluid I. Therefore, if many producing apparatuses 1 of fine particles in accordance with this embodiment are prepared, such an emulsion can be industrially produced.

Furthermore, it is a great advantage that the droplet 3 of about monodispersion of the fluid II can be produced by not using a surfactant without causing attachment to the inner wall of the outer pipe 11 and blocking of the pipe.

The producing apparatus 1 of fine particles in this embodiment is manufactured by combining pipes manufactured by a metal such as stainless steel, etc., resin or glass, sold at a market and having micro inner diameters of about 0.005 mm or more in diameter. The producing apparatus 1 of fine particles can be manufactured by cheap equipment without using the etching technique utilizing photolithography as in the device of patent document 1. Therefore, the emulsion etc. as a product obtained by the producing apparatus 1 of fine particles can be cheaply provided.

In this embodiment, liquid is mainly used as the fluid I, and any fluid can be used as well as water and oil. Gas or liquid having an immiscible property with respect to the fluid I is used as the fluid II. For example, when water is used as the fluid I, oil can be used as the fluid II. When the gas is used as the fluid II, air bubbles are formed instead of the droplet 3. Each of the fluid I and the fluid II may include two substances or more. In this embodiment, both the Reynolds numbers Re of the fluid I and the fluid II can be changed in a range of 1 to 200. The Reynolds number of the fluid I tends to be larger than that of the fluid II.

<Formula Formation of Droplet Producing Condition in Double Pipe>

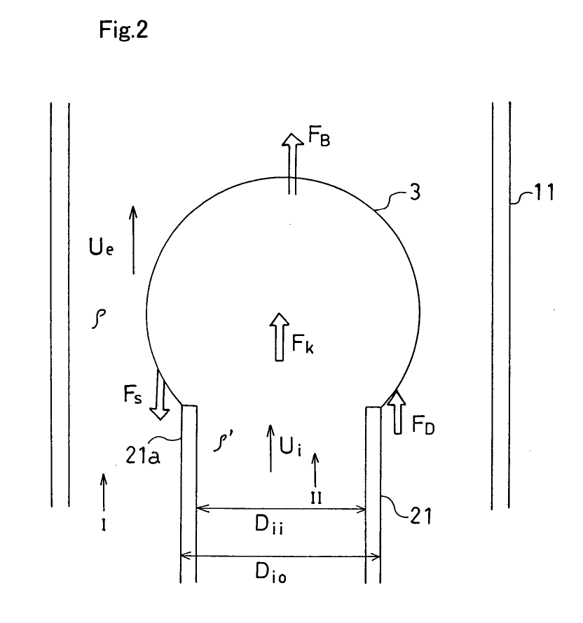

FIG. 2 is a schematic enlarged view of the vicinity of the tip 21a of the inner pipe 21 drawn in FIG. 1. In the state shown in FIG. 2, the droplet of the fluid II begins to be produced from the tip 21a of the inner pipe 21. In this example, four forces constructed by the interfacial tension (FS) between the droplet 3 and the inner pipe 21, buoyant force (FB) of the droplet 3, inertial force (FK) of the fluid II, and fluid force (FD) of the fluid I affecting the droplet 3 are respectively applied to the droplet 3 in the directions shown by arrows in FIG. 2. Accordingly, the balance of the forces in the droplet 3 is represented by the following formula (1).
F_{S}=F_{B}+F_{K}+F_{D} (1)

Here, F_{S} is the interfacial tension (N) between a small particle and the second pipe, and F_{B} is the buoyant force (N) of the fine particle. F_{K} is the inertial force (N) of the fluid II, and F_{D} is the fluid force (N) of the fluid I affecting the fine particle.

In this example, the producing period T (second) of the droplet 3 is represented by the following formula (3).

$$T = \frac{4 π}{3} {( \frac{D}{2} )}^{3} \frac{1}{{Q}_{i}} \qquad ( 3 )$$

Further, the buoyant force (FB) of the droplet 3 is comparatively small in comparison with the other three forces in many cases. Therefore, F_{S}=F_{K}+F_{D} is formed when it is supposed that the buoyant force (FB) of the droplet 3 is small to such an extent that this buoyant force can be neglected in comparison with the other three forces. In this example, a formula apparently writing the diameter D of the droplet 3 as a function of parameters for determining each force is shown as the following formula (2).

$${D}^{2} = {D}_{ii}^{2} + \frac{4 / π}{\frac{1}{2} {C}_{D} ρ {U}_{e}^{2}} [ π γ {D}_{ii} - {ρ}^{′} π \frac{{D}_{ii}^{2}}{4} {U}_{i}^{2} ] \qquad ( 2 )$$

In each of the formulas (1) and (2), the diameter D of the droplet 3 becomes a function of the flow velocities of the fluid I and the fluid II, physical property values (density, viscosity coefficient, interfacial tension coefficient, etc.) of the fluid I and the fluid II, and the inner diameter and the outer diameter of the inner pipe 21. Accordingly, the droplet 3 having the predetermined desirable diameter D can be produced by suitably selecting these values in a forming range of the formula (1) or (2) while the condition of suitably selecting both the physical property values such that the fluid I and the fluid II mutually have the immiscible property is further added. Conversely, in a range in which no formula (1) or (2) is realized, the fluid II exhausted from the tip 21a of the inner pipe 21 becomes a continuous flow, and no droplet 3 is produced.

In the actual producing apparatus 1 of fine particles, the substances of the used fluid I and fluid II, and the inner diameter and the outer diameter of the inner pipe 21 are already determined. Therefore, the predetermined desirable diameter D of the produced droplet 3, the physical property values of the substances of the fluid I and the fluid II, and the inner diameter and the outer diameter of the inner pipe 21 are given to the controller 31 as input data. The controller 31 calculates the flow velocities of the fluid I and the fluid II with respect to the diameter D of the droplet 3 on the basis of the formula (1) or (2) by using these input values. The controller 31 then gives commands to the pumps 14, 24 so as to adjust the flow velocities within the inner pipe 21 and the outer pipe 11 to the calculated flow velocities.

On the other hand, when the physical property values of the substances of the fluid I and the fluid II are already determined but the inner diameter and the outer diameter of the inner pipe 21 are not yet undecided, the flow velocities of the fluid I and the fluid II and the inner diameter and the outer diameter of the inner pipe 21 may be suitably determined so as to obtain the droplet 3 having the predetermined desirable diameter D by using the formula (1) or (2). Thus, the parameters described within the formula (1) or (2) can be changed within a range satisfying the formula (1) or (2) as long as the fluid I and the fluid II are immiscible.

Here, the formula (1) or (2) is derived on the basis of a comparatively simple model as shown in FIG. 2, but the control formula in the controller 31 may be also determined on the basis of a more complicated model. For example, the control formula may also include a parameter showing a smooth degree of the surface of the inner pipe 21 and/or the outer pipe 11, a parameter showing the inner diameter of the outer pipe 11, etc. Conversely, the control formula in the controller 31 may be also determined on the basis of a simpler model.

As can be seen from the formula (1) or (2), the diameter of the droplet 3 is reduced when the speed of the fluid I is raised even when the speed of the fluid II is constant. Further, as the inner diameter of the inner pipe 21 is increased, no production of the droplet 3 is caused at a small flow velocity of the fluid II.

### SECOND EMBODIMENT

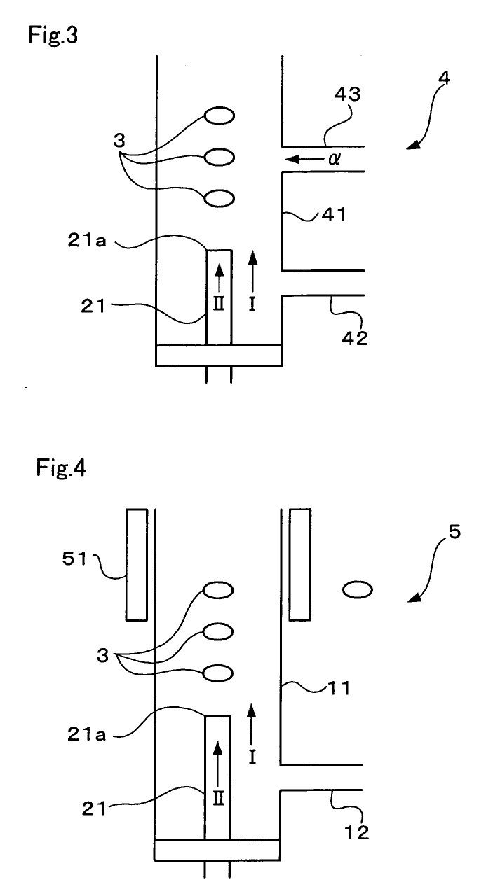

FIG. 3 is a view drawing the schematic construction of a producing apparatus of fine particles in accordance with a second embodiment of the present invention. As shown in FIG. 3, the producing apparatus 4 of fine particles in this embodiment differs from that in the first embodiment in that two branch pipes 42, 43 are provided at an outer pipe 41. Namely, the outer pipe 41 has the branch pipe 42 as a supply source of the fluid I on its base end. The outer pipe 41 also has the branch pipe 43 branched at a region existing in the downstream direction from the tip 21a of an inner pipe 21. Fluid α is supplied from the branch pipe 43 into the outer pipe 41 on the basis of the control of the controller 31. In this embodiment, the formula (1) or (2) is also satisfied.

The fluid α is flowed at a region existing in the downstream direction from the tip 21a of the inner pipe 21 to generate a certain chemical reaction with respect to the fluid II and produce super fine particles within the droplet 3 of the fluid II.

When the fluid II includes a reaction base substance A as one example, the fluid α may also include a reaction base substance B reacting on the reaction base substance A. The reaction base substance A reacts on the reaction base substance B of the fluid α from the surface of the droplet 3 at the region existing in the downstream direction from the branch pipe 43, and the fluid II is changed in property. When the fluid II includes the reaction base substance A as another example, the fluid α may also include a reaction starting agent or a catalyst of a reaction relating to the reaction base substance A. The chemical reaction relating to the reaction base substance A is started from the surface of the droplet 3, or the reaction is rapidly advanced at a region existing in the downstream direction from the branch pipe 43 by the action of the reaction starting agent or the catalyst within the fluid α.

Still another example, when the fluid II includes the reaction base substance A and a reaction base substance B not reacting on the reaction base substance A as it is, the fluid α may also include a reaction starting agent of a reaction relating to the reaction base substance A and the reaction base substance B. The reaction of the reaction base substance A and the reaction base substance B is started from the surface of the droplet 3 by the action of the reaction starting agent within the fluid α at a region existing in the downstream direction from the branch pipe 43, and the fluid II is changed in property. As another example, when the fluid II includes the reaction base substance A and the reaction base substance B, the fluid α may also include a catalyst of the reaction relating to the reaction base substance A and the reaction base substance B. The chemical reaction relating to the reaction base substance A and the reaction base substance B is rapidly advanced from the surface of the droplet 3 of the fluid II by the action of the catalyst within the fluid α at a region existing in the downstream direction from the branch pipe 43.

Still another example, when the fluid II includes the reaction base substance A and the reaction base substance B not reacting on the reaction base substance A as it is, the fluid α may also include a reaction base substance C and a reaction starting agent of a reaction relating to the reaction base substances A to C. In this example, the reaction relating to the reaction base substances A to C is started from the surface of the droplet 3 by the action of the reaction starting agent within the fluid α at a region existing in the downstream direction from the branch pipe 43, and the fluid II is changed in property. As another example, when the fluid II includes the reaction base substance A and the reaction base substance B, the fluid α may include the reaction base substance C and a catalyst of the reaction relating to the reaction base substances A to C. In this example, the chemical reaction relating to the reaction base substances A to C is rapidly advanced from the surface of the droplet 3 of the fluid II by the action of the catalyst within the fluid α at a region existing in the downstream direction from the branch pipe 43.

As still another example, when the fluid II is a solution provided by dissolving a solute in an unsaturated state, the fluid α may be also a solution including a substance deposited as insoluble super fine particles within the fine particles of the fluid II by reacting on the solute within the fluid II. In this example, the solute within the fluid II reacts on the substance within the fluid α at a region existing in the downstream direction from the branch pipe 43, and this substance is deposited as the insoluble super fine particles within the droplet 3.

As still another example, when the fluid II is a solution provided by dissolving a solute in an unsaturated state, the fluid α may be a solution including a substance (poor solvent) for reducing a dissolving degree of the solute within the fluid II such that the fluid II attains a supersaturated state and super fine particles of the solute is deposited into the fine particles of the fluid II. In this example, the solute dissolved into the droplet 3 attains the supersaturated state and the super fine particles are deposited within the droplet 3 by the action of the substance included within the fluid α at a region existing in the downstream direction from the branch pipe 43.

In the above two examples, the deposition of the super fine particles is limited into the droplet. Therefore, there is no possibility that the inner wall of the outer pipe 41 and the tip 21a of the inner pipe 21 are blocked.

The reaction speeds of the above illustrated reactions are very fast since the surface area of the droplet 3 with respect to its volume is large. Furthermore, since the reactions are merely performed within the droplet 3 of a very small size, the reactions unexecutable in the macro chemistry because of an explosively advancement can be executed. Namely, the droplet 3 can be very effectively used practically as a batch reactor of a micro size by arranging the branch pipe 43 as in the producing apparatus 4 of fine particles of this embodiment.

### THIRD EMBODIMENT

FIG. 4 is a view drawing the schematic construction of a producing apparatus of fine particles in accordance with a third embodiment of the present invention. In the third to fifth embodiments, a physical stimulus is utilized instead of the provision of the reaction starting agent or the catalyst as in the second embodiment. In this embodiment, the formula (1) or (2) is also satisfied. As shown in FIG. 4, the producing apparatus 5 of fine particles in this embodiment differs from that in the first embodiment in that a heater 51 is arranged around the outer pipe 11 at a region existing in the downstream direction from the tip 21a of the inner pipe 21. The temperature of the heater 51 is held to an appropriate temperature on the basis of the control of the controller 31. Thus, the fluid I and the droplet 3 are heated at a region existing in the downstream direction from the tip 21a of the inner pipe 21, and their temperatures can be raised.

When the fluid II includes only the reaction base substance A, or also includes the reaction base substance B not reacting on the reaction base substance A as it is as one example, the droplet 3 is heated to a temperature or more for starting the reaction of the reaction base substance A itself, or the reaction base substance A and the reaction base substance B by the heater 51. Thus, the reaction base substance A itself, or the reaction base substance A and the reaction base substance B begin to react within the droplet 3. Since such a reaction is merely performed within the droplet 3 of a very small size, it is very effective similarly to the second embodiment.

### FOURTH EMBODIMENT

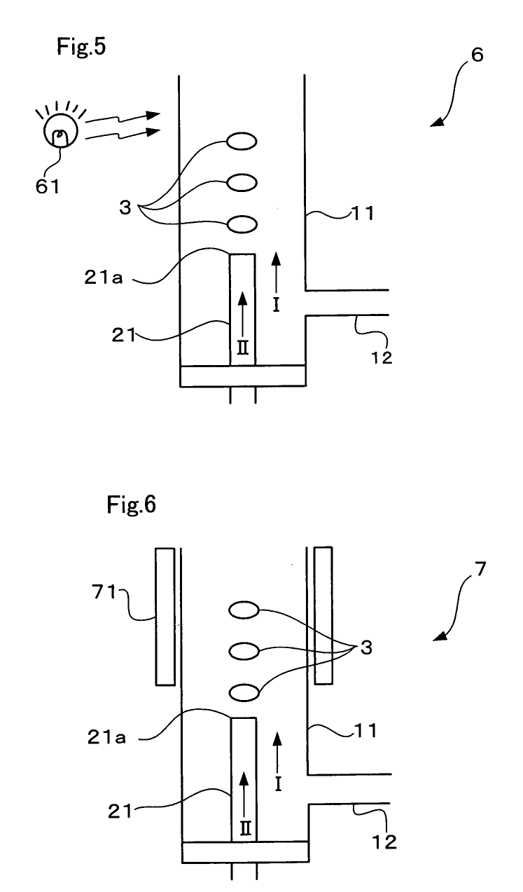

FIG. 5 is a view drawing the schematic construction of a producing apparatus of fine particles in accordance with a fourth embodiment of the present invention. As shown in FIG. 5, the producing apparatus 6 of fine particles in this embodiment differs from that in the first embodiment in that a light source 61 is arranged in the vicinity of the outer pipe 11 at a region existing in the downstream direction from the tip 21a of the inner pipe 21. In this embodiment, the formula (1) or (2) is also satisfied. The light source 61 emits light of appropriate intensity on the basis of the control of the controller 31. This light irradiates the fluid I and the droplet 3 at a region existing in the downstream direction from the tip 21a of the inner pipe 21.

When the fluid II includes only the reaction base substance A, or also includes the reaction base substance B not reacting on the reaction base substance A as it is as one example, the light emitted from the light source 61 is irradiated at a region existing in the downstream direction from the tip 21a of the inner pipe 21 so as to start a reaction relating to the reaction base substance A itself, or the reaction base substance A and the reaction base substance B. Thus, the reaction base substance A itself, or the reaction base substance A and the reaction base substance B are optically started within the droplet 3. Similar to the second embodiment, such a reaction is very effective since this reaction is merely performed within the droplet 3 of a very small size.

### FIFTH EMBODIMENT

FIG. 6 is a view drawing the schematic construction of a producing apparatus of fine particles in accordance with a fifth embodiment of the present invention. As shown in FIG. 6, the producing apparatus 7 of fine particles in this embodiment differs from that in the first embodiment in that a cooling device 71 is arranged around the outer pipe 11 at a region existing in the downstream direction from the tip 21a of the inner pipe 21. In this embodiment, the formula (1) or (2) is also satisfied. The temperature of the cooling device 71 is held to an appropriate temperature on the basis of the control of the controller 31. Thus, the fluid I and the droplet 3 are cooled at a region existing in the downstream direction from the tip 21a of the inner pipe 21, and their temperatures can be lowered.

When the fluid II is a solution provided by dissolving a solute in an unsaturated state as one example, a region existing in the downstream direction from the tip 21a of the inner pipe 21 is rapidly cooled by the cooling device 71 such that the fluid II attains a supersaturated state and super fine particles of the solute are deposited into the droplet 3 of the fluid II. Thus, the solute within the fluid II is deposited within the droplet 3 as insoluble super fine particles.

### SIXTH EMBODIMENT

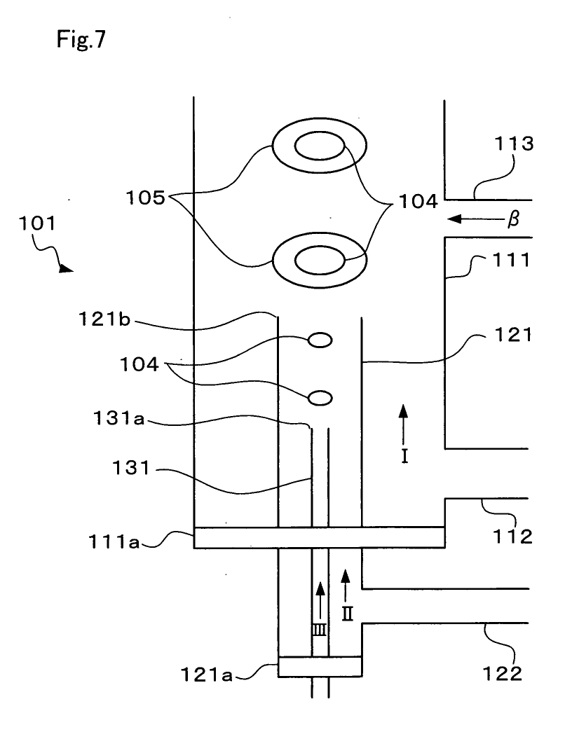

FIG. 7 is a view drawing the schematic construction of a producing apparatus of fine particles in accordance with a sixth embodiment of the present invention. As shown in FIG. 7, the producing apparatus 101 of fine particles in this embodiment includes three pipes constructed by an outer pipe (first pipe) 111, an intermediate pipe 121 (second pipe) and an inner pipe (third pipe) 131. These pipes are circular pipes and are arranged in a concentric shape. The inner pipe 131 is extended in the axial direction from a base end 121a of the intermediate pipe 121 to its tip 121b. The length of the inner pipe 131 within the intermediate pipe 121 is sufficiently shorter than the length of the intermediate pipe 121. The tip 131a of the inner pipe 131 is spaced from the tip 121b of the intermediate pipe 121 by a comparatively long distance. The intermediate pipe 121 is extended in the axial direction from a base end 111a of the outer pipe 111 to its unillustrated tip. The length of the intermediate pipe 121 within the outer pipe 111 is sufficiently shorter than the length of the outer pipe 111. The tip 121b of the intermediate pipe 121 is spaced from the tip of the outer pipe 111 by a comparatively long distance.

An unillustrated pump is connected to the base end of the inner pipe 131. The pump sends-out fluid (liquid or gas) (hereinafter called “fluid III”) within the unillustrated tank into the inner pipe 131 as a dispersion phase on the basis of commands from an unillustrated controller. A branch pipe 122 is connected to the vicinity (at least an upstream portion from the tip 131a of the inner pipe 131) of the base end 121a of the intermediate pipe 121. An unillustrated pump is connected to this branch pipe 122. The pump sends-out fluid (liquid or gas) (hereinafter called “fluid II”) within the unillustrated tank into the intermediate pipe 121 as a dispersion phase through the branch pipe 122 on the basis of commands from the controller. A branch pipe 112 is connected to the vicinity (at least an upstream portion from the tip 121b of the intermediate pipe 121) of the base end 111a of the outer pipe 111. An unillustrated pump is connected to this branch pipe 112. This pump sends-out fluid (liquid or gas) (hereinafter called “fluid I”) within the unillustrated tank into the outer pipe 111 as a continuous phase through the branch pipe 112 on the basis of commands from the controller.

When all of the outer pipe 111, the intermediate pipe 121 and the inner pipe 131 are filled with the fluid I, the fluid II and the fluid III in the producing apparatus 101 of fine particles, the flow velocities of the fluid I, the fluid II and the fluid III within the outer pipe 111, the intermediate pipe 121 and the inner pipe 131 are adjusted to appropriate values selected on the basis of the formula (1) or (2) by controlling the operation of each pump by commands from the controller. Thus, the fluid III exhausted from the tip 131a of the inner pipe 131 can become a droplet 104 having a predetermined desirable diameter and a spherical shape surrounded by the fluid II within the intermediate pipe 121. Further, the fluid II exhausted from the tip 121b of the intermediate pipe 121 can become a droplet (micro capsule) 105 of a double structure having a predetermined desirable diameter and a spherical shape surrounding one or more droplets 104 of the fluid III within the outer pipe 121. When the controller selects the flow velocities of the fluid I, the fluid II and the fluid III, data relating to the sizes of the outer pipe 111, the intermediate pipe 121 and the inner pipe 131 and data relating to physical property values of the fluid I, the fluid II and the fluid III are inputted from the exterior to the controller in advance. If the flow velocities of the fluid I, the fluid II and the fluid III are constant, the droplets 104, 105 are produced every predetermined time interval. The droplet 105 exhausted from the tip 121b of the intermediate pipe 121 is moved toward the tip of the outer pipe 111. The fluid I including the droplet 105 is introduced into the connected tank from the tip of the outer pipe 111.

Thus, for example, it is possible to rapidly produce a mixture in which the droplets 105 of the double structure as fine particles of high quality of a micro size such as an emulsion are sufficiently uniformly distributed within the fluid I. Therefore, if many producing apparatuses 101 of fine particles in this embodiment are prepared, such an emulsion can be industrially produced. Further, similar to the first embodiment, the producing apparatus 101 of fine particles in this embodiment is manufactured by combining pipes sold at a market and having micro inner diameters. Accordingly, this producing apparatus 101 of fine particles can be manufactured by cheap equipment without using an etching technique utilizing photolithography as in the device of patent document 1. Therefore, the emulsion, etc. as a product obtained by the producing apparatus 101 of fine particles can be cheaply provided.

Further, the outer pipe 111 has a branch pipe 113 branched at a region existing in the downstream direction from the tip 121b of the intermediate pipe 121. Fluid β can be supplied from the branch pipe 113 into the outer pipe 111 on the basis of the control of the controller. When the fluid β is supplied from the branch pipe 113 into the outer pipe 111 and the droplet 105 reaches a region existing in the downstream direction from the branch pipe 113, a certain chemical reaction can be generated with respect to the fluid II constituting the outer shell of the droplet 105, and super fine particles can be produced within the fluid II constituting the outer shell of the droplet 105 by the action of the fluid β.

When the fluid II includes the reaction base substance A as one example, the fluid β may also include the reaction base substance B reacting on the reaction base substance A. In this example, the reaction base substance A reacts on the reaction base substance B of the fluid β from the surface of the droplet 105 at a region existing in the downstream direction from the branch pipe 113, and the fluid II is changed in property. Further, as another example, when the fluid II includes the reaction base substance A, the fluid β may also include a reaction starting agent or a catalyst of a reaction relating to the reaction base substance A. In this example, the chemical reaction relating to the reaction base substance A is started or the reaction is rapidly advanced from the surface of the droplet 105 at a region existing in the downstream direction from the branch pipe 113 by the action of the reaction starting agent or the catalyst within the fluid β.

As still another example, when the fluid II includes the reaction base substance A and the reaction base substance B not reacting on the reaction base substance A as it is, the fluid β may also include a reaction starting agent of a reaction relating to the reaction base substance A and the reaction base substance B. In this example, the reaction of the reaction base substance A and the reaction base substance B is started from the surface of the droplet 105 by the action of the reaction starting agent within the fluid β at a region existing in the downstream direction from the branch pipe 113, and the fluid II is changed in property. When the fluid II includes the reaction base substance A and the reaction base substance B as another example, the fluid β may also include a catalyst of the reaction relating to the reaction base substance A and the reaction base substance B. In this example, the chemical reaction relating to the reaction base substance A and the reaction base substance B is rapidly advanced from the surface of the droplet 105 of the fluid II by the action of the catalyst within the fluid β at a region existing in the downstream direction from the branch pipe 113.

When the fluid II includes the reaction base substance A and the reaction base substance B not reacting on the reaction base substance A as it is as still another example, the fluid β may also include a reaction base substance C and a reaction starting agent of a reaction relating to the reaction base substances A to C. In this example, the reaction relating to the reaction base substances A to C is started from the surface of the droplet 105 by the action of the reaction starting agent within the fluid β at a region existing in the downstream direction from the branch pipe 113, and the fluid II is changed in property. When the fluid II includes the reaction base substance A and the reaction base substance B as another example, the fluid β may include the reaction base substance C and a catalyst of the reaction relating to the reaction base substances A to C. In this example, the chemical reaction relating to the reaction base substances A to C is rapidly advanced from the surface of the droplet 105 of the fluid II by the action of the catalyst within the fluid β at a region existing in the downstream direction from the branch pipe 113.

In the above examples, the fluid II changed in property may further also react on the fluid III of the droplet 104 within this fluid II.

When the fluid II is a solution provided by dissolving a solute in an unsaturated state as still another example, the fluid β may be a solution including a substance deposited as insoluble super fine particles within the fine particles of the fluid II by reacting on the solute within the fluid II. In this example, the solute within the fluid II reacts on the substance within the fluid β, and this substance is deposited as the insoluble super fine particles within the droplet 105 at a region existing in the downstream direction from the branch pipe 113.

When the fluid II is a solution provided by dissolving a solute in an unsaturated state as still another example, the fluid β may be a solution including a substance (poor solvent) for reducing a dissolving degree of the solute within the fluid II such that the fluid II attains a supersaturated state and super fine particles of the solute are deposited within the fine particles of the fluid II. In this example, the solute dissolved into the droplet 105 attains the supersaturated state and the super fine particles are deposited within the droplet 105 by the action of the substance included within the fluid β at a region existing in the downstream direction from the branch pipe 113.

The depositing amount of the super fine particles deposited in the above two examples can be controlled by the size of the outer shell of the droplet 105. Further, the unification of producing nuclei of the super fine particles is restrained. Furthermore, differing from a case in which the deposition is caused in the tip 121b of the intermediate pipe 121, there is no possibility that the tip 121b of the intermediate pipe 121 is blocked due to the deposited super fine particles.

The reaction speeds of the above illustrated reactions are very fast since the surface area of the droplet 105 with respect to its volume is large. Further, since these reactions are merely performed within the outer shell of the droplet 105 of a very small size, the reactions unexecutable in the macro chemistry because of an explosively advancement can be executed. Namely, the droplet 105 of the double structure can be very effectively used practically as a batch reactor of a micro size by arranging the branch pipe 113 as in the producing apparatus 101 of fine particles of this embodiment.

In this embodiment, any fluid can be used as the fluid I and the fluid II if liquid is mainly used and this fluid mutually has an immiscible property in addition to water and oil. Gas or liquid having the immiscible property with respect to the fluid II is used as the fluid III. When the gas is used as the fluid III, air bubbles are formed instead of the droplet 104 and the droplet 105 includes the air bubbles at the center. Each of the fluid I, the fluid II and the fluid III may include two substances or more. In this embodiment, the Reynolds numbers Re of the fluid I, the fluid II and the fluid III can be changed in a range of 1 to 200. The Reynolds number of the fluid I tends to be greater than that of the fluid II, and the Reynolds number of the fluid II tends to be greater than that of the fluid III.

### SEVENTH EMBODIMENT

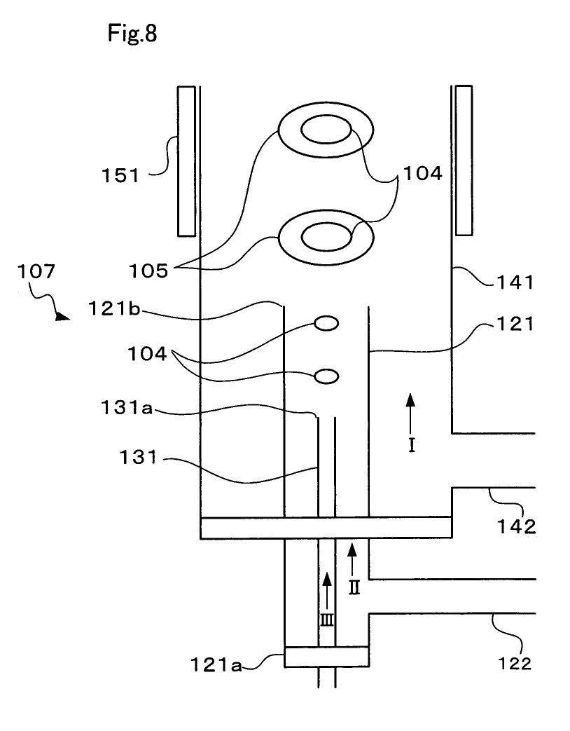

FIG. 8 is a view drawing the schematic construction of a producing apparatus of fine particles in accordance with a seventh embodiment of the present invention. As shown in FIG. 8, the producing apparatus 107 of fine particles in this embodiment differs from that in the sixth embodiment in that an outer pipe 141 having a branch pipe 142 for supplying the fluid I has no branch pipe at a region existing in the downstream direction from the tip 121b of the intermediate pipe 121, and a heater 151 is arranged around the outer pipe 141 at a region existing in the downstream direction from the tip 121b of the intermediate pipe 121. In this embodiment, the flow velocities of the fluid I, the fluid II and the fluid III within the outer pipe 111, the intermediate pipe 121 and the inner pipe 131 are also selected on the basis of the formula (1) or (2). The temperature of the heater 151 is held to an appropriate temperature on the basis of the control of the controller. Thus, the fluid I and the droplet 105 are heated at a region existing in the downstream direction from the tip 121b of the intermediate pipe 121, and their temperatures can be raised.

When the fluid II includes only the reaction base substance A, or also includes the reaction base substance B not reacting on the reaction base substance A as it is as one example, the droplet 105 is heated to not lower than a temperature for starting the reaction of the reaction base substance A itself, or the reaction base substance A and the reaction base substance B by the heater 151. Thus, the reaction base substance A itself, or the reaction base substance A and the reaction base substance B begin to react within the droplet 105. Similar to the sixth embodiment, it is very effective since such a reaction is merely performed within the droplet 105 of a very small size.

In FIG. 8, a cooling device may be also arranged instead of the heater 151. Thus, the fluid I and the droplet 105 are cooled at a region existing in the downstream direction from the tip 121b of the intermediate pipe 121, and their temperatures can be lowered.

When the fluid II is a solution provided by dissolving a solute in an unsaturated state as one example, a region existing in the downstream direction from the tip 121b of the intermediate pipe 121 is rapidly cooled by the cooling device such that the fluid II attains a supersaturated state and super fine particles of the solute are deposited in the outer shell of the droplet 105. Thus, the solute within the fluid II is deposited within the outer shell of the droplet 105 as insoluble super fine particles.

### EIGHTH EMBODIMENT

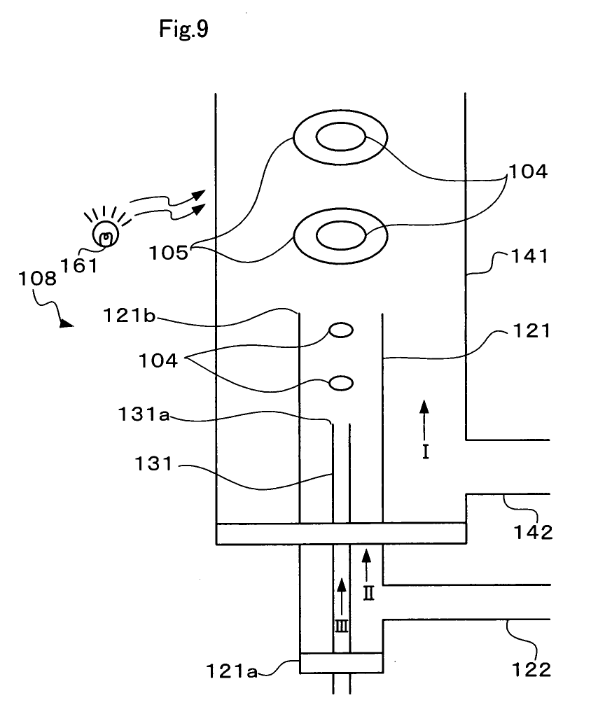

FIG. 9 is a view drawing the schematic construction of a producing apparatus of fine particles in accordance with an eighth embodiment of the present invention. As shown in FIG. 9, this producing apparatus 108 of fine particles in this embodiment differs from that in the seventh embodiment in that a light source 161 is arranged in the vicinity of the outer pipe 141 at a region existing in the downstream direction from the tip 121b of the intermediate pipe 121. In this embodiment, the flow velocities of the fluid I, the fluid II and the fluid III within the outer pipe 111, the intermediate pipe 121 and the inner pipe 131 are also selected on the basis of the formula (1) or (2). The light source 161 emits light of appropriate intensity on the basis of the control of the controller. This light irradiates the fluid I and the droplet 105 at a region existing in the downstream direction from the tip 121b of the intermediate pipe 121.

As one example, when the fluid II includes only the reaction base substance A, or also includes the reaction base substance B not reacting on the reaction base substance A as it is, the light emitted from the light source 161 is irradiated onto a region existing in the downstream direction from the tip 121b of the intermediate pipe 121 so as to start a reaction relating to the reaction base substance A itself, or the reaction base substance A and the reaction base substance B. Thus, a photo-polymerization reaction of the reaction base substance A itself, or the reaction base substance A and the reaction base substance B is started within the outer shell of the droplet 105. Similar to the seventh embodiment, such a reaction is very effective since it is merely performed within the outer shell of the droplet 105 of a very small size.

The preferred embodiments of the present invention have been explained above, but the present invention is not limited to the above embodiments. The present invention can be variously modified and changed as long as these modifications and changes are in the scope of the claims. For example, the following modifications can be adopted in the producing apparatus of fine particles of the present invention.

(a) Mass production of the fine particles can be performed by combining many producing apparatuses of fine particles of the present invention.

(b) Each pipe may be horizontally arranged, or may be also slantingly arranged.

(c) Substance included in the fluid can be suitably changed according to applications.

(d) The fine particles can be produced by using four or more concentric pipes.

(e) The sectional shape of a hollow portion of each pipe may be a shape except for a circular shape. For example, a pipe of a polygonal shape in section may be also used.

(f) A physical stimulus such as ultrasonic irradiation, electromagnetic irradiation, etc. except for a temperature change or light irradiation may be also given. The kind of the physical stimulus is selected in accordance with the reactive property of the reaction base substance.

### EMBODIMENT 1

(1-1) An emulsion dispersing silicon oil therein was produced by the producing apparatus 1 of fine particles drawn in FIG. 1. Water (density 997 kg/m³, viscosity 0.77 mPa·s) was used as the fluid I (continuous phase), and silicon oil (density 760 kg/m³, viscosity 0.65 mPa·s) was used as the fluid II (dispersion phase). In this example, as shown below, three different kinds (#1, #2, #3) of the sizes of the inner pipe 21 and the outer pipe 11 were prepared as the producing apparatus 1 of fine particles.

| Pipe | Inner diameter | Outer diameter of | Inner diameter of |
|---|---|---|---|
| No. | of inner pipe | inner pipe | outer pipe (mm) |
| #1 | 0.24 | 0.40 | 2.30 |
| #2 | 0.25 | 0.40 | 1.30 |
| #3 | 0.13 | 0.29 | 1.30 |

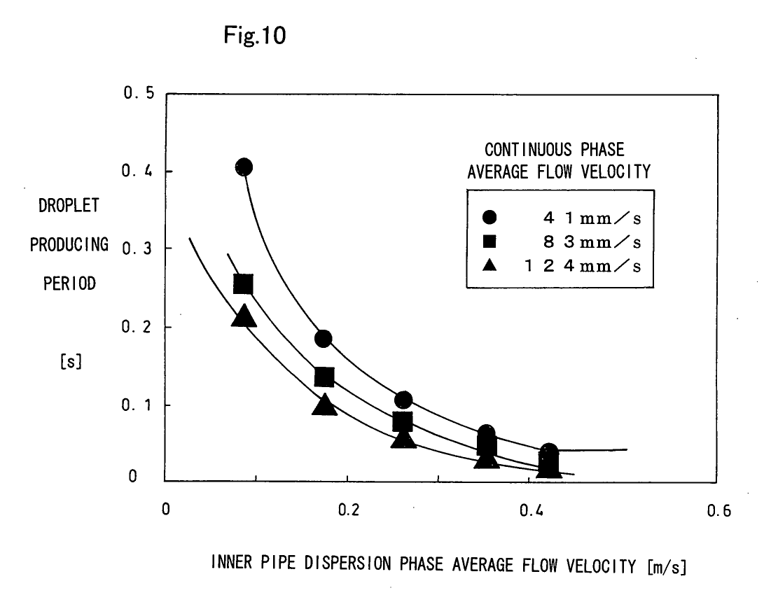

While the flow velocities of the fluid I and the fluid II were changed to several kinds by using the apparatus 1 of #2, the diameter of the produced droplet 3 and its producing period were measured. A syringe pump was used as the pumps 14, 24. A CCD high speed video camera was used to observe the produced droplet 3. As this result, the obtained relation of the flow velocities of the fluid I and the fluid II and the producing period of the droplet 3 is shown in FIG. 10.

As can be seen from FIG. 10, when the flow velocity of the fluid II as the dispersion phase is increased, the producing period of the droplet 3 is shortened. Further, the producing speed of the droplet 3 is shortened even when the flow velocity of the fluid I as the continuous phase is increased.

It is supposed that the droplet has a spherical shape, and the diameter of the droplet 3 is calculated from the flow amount of the dispersion phase and the producing period of the droplet. The calculated diameter of the droplet 3 is dispersed within 3% of an average particle diameter. Accordingly, it has become clear that an emulsion very close to monodispersion and having a uniform particle diameter is produced. Similar results were also obtained in cases using the apparatuses 1 of #1 and #3.

(1-2) An emulsion dispersing cyclohexane therein was produced by using water as the fluid I (continuous phase), and cyclohexane (density 779 kg/m³, viscosity 0.898 mPa·s) as the fluid II (dispersion phase) by the producing apparatus 1 of fine particles drawn in FIG. 1. In this example, as shown below, two different kinds (#4, #5) of the sizes of the inner pipe 21 and the outer pipe 11 were prepared as the producing apparatus 1 of fine particles.

| Pipe | Inner diameter | Outer diameter | Inner diameter of |
|---|---|---|---|
| No. | of inner pipe | of inner pipe | outer pipe (mm) |
| #4 | 0.08 | 0.18 | 0.32 |
| #5 | 0.16 | 0.32 | 2.1 |

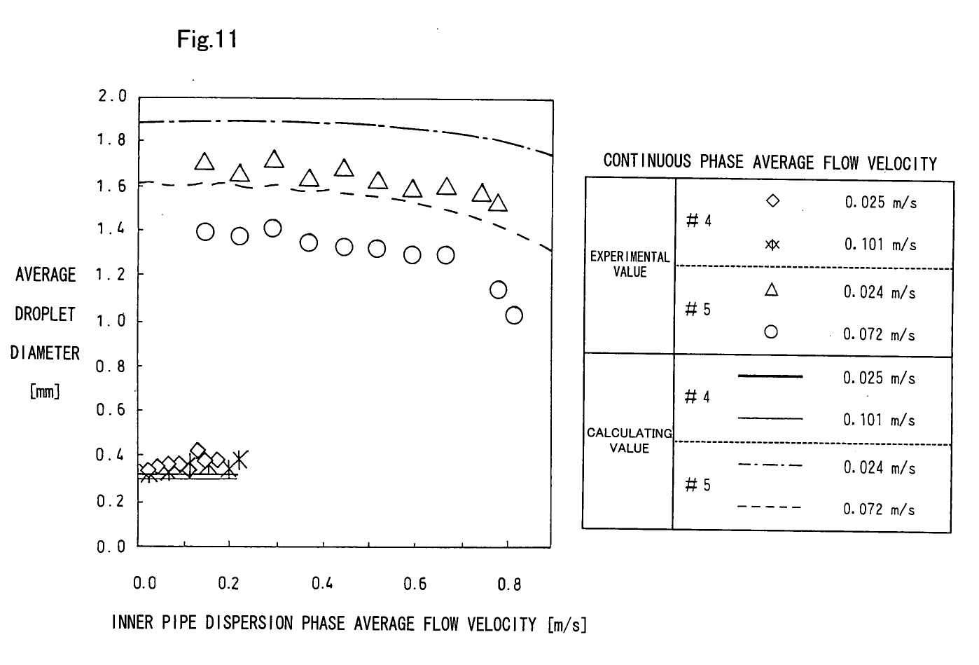

While the flow velocities of the fluid I and the fluid II were changed to several kinds by using the apparatuses 1 of #4 and #5, the diameter of the produced droplet 3 and its producing period were measured. Further, it is supposed that the droplet has a spherical shape, and the diameter of the droplet 3 is calculated from the flow amount of the dispersion phase and the producing period of the droplet. The relation of the calculated diameter of the droplet 3 and the flow velocities of the fluid I and the fluid II is shown in FIG. 11. Calculating values calculated from the formula (2) are shown together within FIG. 11. It is known from FIG. 11 that the formula (2) can be sufficiently utilized as an approximate formula for calculating the diameter of the droplet 3.

### EMBODIMENT 2

(2-1) Nylon 6, 6 was produced by using the producing apparatus 4 of fine particles (inner pipe inner diameter 0.17 mm, inner pipe outer diameter 0.35 mm, outer pipe inner diameter 2.10 mm) drawn in FIG. 3. Water was used as the fluid I (continuous phase), and a mixing liquid of dichloride adipate and hexane (density 659 kg/m³, viscosity 0.29 mPa·s) was used as the fluid II (dispersion phase). Hexamethylene diamine and an aqueous solution of sodium hydroxide having an amount equal to that of the fluid I were supplied as the fluid α from the branch pipe 43. The flow velocity of the fluid II was set to 0.050 m/s, and the flow velocity of the fluid II was set to 0.586 m/s.

As this result, the droplet 3 was obtained and the dichloride adipate, the hexamethylene diamine and the aqueous solution of sodium hydroxide came in contact with each other on the surface of the droplet 3 at a region existing in the downstream direction from the branch pipe 43, and a polymerization reaction was started. Thus, nylon 6, 6 having an average diameter of 1.41 mm (a changing coefficient 2.1%) as a polymer was formed. Further, when the flow velocity of the fluid II was set to 1.32 m/s, the average particle diameter was 0.57 mm.

(2-2) Super fine particles of anatase type titanium oxide were produced within the droplet by using the producing apparatus 4 of fine particles (inner pipe inner diameter 0.88 mm, inner pipe outer diameter 1.60 mm, outer pipe inner diameter 3.00 mm) drawn in FIG. 3. Isopropanol (density 786 kg/m³, viscosity 2.43 mPa·s) was used as the fluid I (continuous phase), and liquid provided by diluting titanium tetra isopropoxide (Ti(OC₃H₇)₄) with cyclohexane by ten times was used as the fluid II (dispersion phase). Water having an amount equal to that of isopropanol was supplied from the branch pipe 43 as the fluid α. The flow velocity of the fluid I was set to 0.05 m/s and the flow velocity of the fluid II was set to 0.075 m/s.

As this result, the droplet 3 was obtained, and the titanium tetra isopropoxide and the water reacted at a region existing in the downstream direction from the branch pipe 43, and super fine particles (diameter about 9 nm to 10 nm, and average diameter 7 nm) of the anatase type titanium oxide were deposited within the fluid II. Further, similar results were obtained when the inner diameter of the outer pipe was set to 2.5 mm, and the flow velocity of the fluid I was set to 0.05 m/s, and the flow velocity of the fluid II was set to 0.075 m/s.

### EMBODIMENT 3

(3-1) A hollow emulsion including air bubbles was produced by using the producing apparatus 101 of fine particles drawn in FIG. 7. Water was used as the fluid I (continuous phase), and a mixture of dichloride adipate and hexane was used as the fluid II (dispersion phase). Further, the air (density 1.2 kg/m³) was used as the fluid III. The flow velocity of the fluid II was set to 0.045 m/s, and the flow velocity of the fluid II was set to 0.189 m/s, and the flow velocity of the fluid III was set to 2.95 m/s. In this example, the following pipes (#6) were prepared as the producing apparatus 101 of fine particles.

| | | | | | Inner |
|---|---|---|---|---|---|
| | Inner | Outer | Inner | Outer | diameter |
| | diameter | diameter | diameter of | diameter of | of outer |
| Pipe | of inner | of inner | intermediate | intermediate | pipe |
| No. | pipe | pipe | pipe | pipe | (mm) |
| #6 | 0.12 | 0.20 | 0.31 | 0.36 | 2.20 |

As this result, the droplet 105 having about 1.0 to 1.2 mm in diameter as a hollow emulsion internally including air bubbles (fluid III) of about 0.9 to 1.1 mm in diameter was exhausted from the tip 121b of the intermediate pipe 121.

(3-2) After the droplet 105 as a hollow emulsion was produced as mentioned above, the hexamethylene diamine and the aqueous solution of sodium hydroxide having an amount equal to that of the fluid I were supplied from the branch pipe 113 as the fluid β. In this example, the dichloride adipate of the fluid II as the outer shell of the droplet 105, and the hexamethylene diamine and the aqueous solution of sodium hydroxide of the fluid β came in contact with each other on the surface of the droplet 105 at a region existing in the downstream direction from the branch pipe 113. Thus, a polymerization reaction was started, and the outer shell of the droplet 105 became nylon 6, 6 (about 1.0 to 1.4 mm in diameter). Particles of this nylon 6, 6 became hollow particles internally including the air.

It has been also confirmed that a capsule internally possessing liquid is produced by flowing liquid immiscible with respect to the fluid II as the fluid III.

1. A method for producing fine particles by using a first pipe for flowing fluid I therethrough, and a second pipe for flowing fluid II therethrough and arranged such that one end of the second pipe exists within said first pipe and the vicinity of said one end is extended substantially in parallel with the axial direction of said first pipe;
wherein the fluid I and the fluid II are respectively flowed to said first and second pipes by selecting flow velocities and physical property values of the fluid I and the fluid II and the sizes of said first and second pipes satisfying the following formula (1) such that the fluid II exhausted from said one end of said second pipe becomes fine particles surrounded by the fluid I within said first pipe,
F_{S}=F_{B}+F_{K}+F_{D} (1)
where
F_{S}=πγDᵢᵢ—interfacial tension (N) between the fine particles and the second pipe,
$${F}_{B} = λ \frac{4}{3} {π ( \frac{D}{2} )}^{3} g Δ ρ$$
—buoyant force (N) of the fine particles,
F_{K}=ρ′UᵢQᵢ—inertial force (N) of the fluid II, and
$${F}_{D} = \frac{{C}_{D}}{2} ρ {U}_{e}^{2} \frac{π}{4} ( {D}^{2} - {D}_{ii}^{2} )$$
—fluid force (N) of the fluid I affecting the fine particles,
γ: interfacial tension coefficient (N/m),
g: acceleration of gravity,
λ: coefficient,
D: diameter (m) of the fine particle,
Δρ=ρ−ρ′ (ρ: density (kg/m³) of the fluid I, ρ′: density (kg/m³) of the fluid II),
Uᵢ: average flow velocity (m/s) of the fluid II,
Uₑ: average flow velocity (m/s) of the fluid I around the fine particles,
$${Q}_{i} = \frac{π}{4} {D}_{ii}^{2} {U}_{i} \text{:}$$
flow rate (m³/s) of the fluid II (Dᵢᵢ: inner diameter of the second pipe), and
C_{D}: flow resistance coefficient of the fine particles,
$${C}_{D} = \frac{κ}{Re} = \frac{κ}{{U}_{e} D {ρ}^{′}} μ$$
(Re: Reynolds number, κ: constant, μ: viscosity coefficient of the fluid I).

2. A method for producing fine particles by using a first pipe for flowing fluid I therethrough, and a second pipe for flowing fluid II therethrough and arranged such that one end of the second pipe exists within said first pipe and the vicinity of said one end is extended substantially in parallel with the axial direction of said first pipe;
wherein the fluid I and the fluid II are respectively flowed to said first and second pipes by selecting flow velocities and physical property values of the fluid I and the fluid II and the sizes of said first and second pipes satisfying the following formula (2) such that the fluid II exhausted from said one end of said second pipe becomes fine particles surrounded by the fluid I within said first pipe,
$${D}^{2} = {D}_{ii}^{2} + \frac{4 / π}{\frac{1}{2} {C}_{D} ρ {U}_{e}^{2}} [ πγ {D}_{ii} - {ρ}^{′} π \frac{{D}_{ii}^{2}}{4} {U}_{i}^{2} ] \qquad ( 2 )$$
γ: interfacial tension coefficient (N/m),
D: diameter (m) of the fine particle,
ρ: density (kg/m³) of the fluid I,
ρ′: density (kg/m³) of the fluid II,
Uᵢ: average flow velocity (m/s) of the fluid II,
Uₑ: average flow velocity (m/s) of the fluid I around the fine particles,
Dᵢᵢ: inner diameter of the second pipe, and
C_{D}: flow resistance coefficient of the fine particles,
$${C}_{D} = \frac{κ}{Re} = \frac{κ}{{U}_{e} D {ρ}^{′}} μ$$
(Re: Reynolds number, κ: constant, μ: viscosity coefficient of the fluid I).

3. The method for producing fine particles according to claim 1, wherein the fluid II is gas and the fine particles are air bubbles.

4. The method for producing fine particles according to claim 1, wherein fluid α is flowed into said first pipe at a region existing in the downstream direction from said one end of said second pipe.

5. The method for producing fine particles according to claim 4, wherein the fluid II includes a reaction base substance A, and
the fluid α includes at least one of a reaction base substance B reacting on the reaction base substance A, and a reaction starting agent or a catalyst of a reaction relating to the reaction base substance A.

6. The method for producing fine particles according to claim 1, wherein the fluid II is a solution dissolving a solute therein, and
super fine particles of the solute are deposited within the fine particles of the fluid II.

7. The method for producing fine particles according to claim 4, wherein the fluid II is a solution dissolving a solute therein, and
the fluid α is a solution including a substance deposited as insoluble super fine particles within the fine particles of the fluid II by reacting on said solute within the fluid II.

8. The method for producing fine particles according to claim 1, wherein said first and second pipes are pipes constructed by one of a metal, glass and resin.

9. A method for producing fine particles by using a first pipe for flowing fluid I therethrough; a second pipe for flowing fluid II therethrough and arranged such that one end of the second pipe exists within said first pipe and the vicinity of said one end is extended substantially in parallel with the axial direction of said first pipe; and a third pipe for flowing fluid III therethrough and arranged such that one end of the third pipe exists within said second pipe and the vicinity of said one end of the third pipe is extended substantially in parallel with the axial direction of said second pipe;
wherein the fluid I, the fluid II and the fluid III are respectively flowed to said first, second and third pipes by selecting flow velocities and physical property values of the fluid I, the fluid II and the fluid III, and the sizes of said first, second and third pipes such that the fluid III exhausted from said one end of said third pipe becomes fine particles surrounded by the fluid II within said second pipe, and the fluid II exhausted from said one end of said second pipe becomes fine particles of a double structure surrounding one or more fine particles of the fluid III within said first pipe.

10. The method for producing fine particles according to claim 9, wherein fluid β is flowed into said first pipe at a region existing in the downstream direction from said one end of said second pipe.

11. The method for producing fine particles according to claim 10, wherein the fluid II includes a reaction base substance A, and
the fluid β includes at least one of a reaction base substance B reacting on the reaction base substance A, and a reaction starting agent or a catalyst of a reaction relating to the reaction base substance A.

12. A method for producing fine particles by using n-pipes (n: a natural number of 3 or more) coaxially arranged with respect to each other such that one end of an n-th pipe for flowing n-th fluid therethrough exists within an (n−1)-th pipe arranged outside the n-th pipe, and the vicinity of said one end of the n-th pipe is extended substantially in parallel with the axial direction of said (n−1)-th pipe;
wherein, when m is any value of natural numbers of n−2 or less, m-th, (m+1)-th and (m+2)-th fluids are respectively flowed to said m-th, (m+1)-th and (m+2)-th pipes by selecting flow velocities and physical property values of the m-th, (m+1)-th and (m+2)-th fluids and the sizes of said m-th, (m+1)-th and (m+2)-th pipes such that the fine particles of the (m+1)-th fluid surrounding one or more fine particles of the (m+2)-th fluid exhausted from one end of the (m+2)-th pipe are exhausted from one end of the m-th pipe.

13. A producing apparatus of fine particles comprising:
a first pipe for flowing fluid I therethrough;
a second pipe for flowing fluid II therethrough and arranged such that one end of the second pipe exists within said first pipe and the vicinity of said one end is extended substantially in parallel with the axial direction of said first pipe; and
flow velocity control means for controlling the flow velocities of the fluid I and the fluid II on the basis of physical property values of the fluid I and the fluid II and the sizes of said first and second pipes such that the fluid II exhausted from said one end of said second pipe becomes fine particles surrounded by the fluid I within said first pipe;
wherein said flow velocity control means controls the flow velocities of the fluid I and the fluid II so as to satisfy the following formula (1),
F_{S}=F_{B}+F_{K}+F_{D} (1)
where
F_{S}=πγDᵢᵢ—interfacial tension (N) between the fine particles and the second pipe,
$${F}_{B} = λ \frac{4}{3} {π ( \frac{D}{2} )}^{3} g Δ ρ$$
—buoyant force (N) of the fine particles,
F_{K}=ρ′UᵢQᵢ—inertial force (N) of the fluid II, and
$${F}_{D} = \frac{{C}_{D}}{2} ρ {U}_{e}^{2} \frac{π}{4} ( {D}^{2} - {D}_{ii}^{2} )$$
—fluid force (N) of the fluid I affecting the fine particles,
γ: interfacial tension coefficient (N/m),
g: acceleration of gravity,
λ: coefficient,
D: diameter (m) of the fine particle,
Δρ=ρ−ρ′ (ρ: density (kg/m³) of the fluid I, ρ′: density (kg/m³) of the fluid II),
Uᵢ: average flow velocity (m/s) of the fluid II,
Uₑ: average flow velocity (m/s) of the fluid I around the fine particles,
$${Q}_{i} = \frac{π}{4} {D}_{ii}^{2} {U}_{i}$$
: flow rate (m³/s) of the fluid II (Dᵢᵢ: inner diameter of the second pipe), and
C_{D}: flow resistance coefficient of the fine particles,
$${C}_{D} = \frac{κ}{Re} = \frac{κ}{{U}_{e} D {ρ}^{′}} μ$$
(Re: Reynolds number, κ: constant, μ: viscosity coefficient of the fluid I).

14. A producing apparatus of fine particles comprising:
a first pipe for flowing fluid I therethrough;
a second pipe for flowing fluid II therethrough and arranged such that one end of the second pipe exists within said first pipe and the vicinity of said one end is extended substantially in parallel with the axial direction of said first pipe; and
flow velocity control means for controlling the flow velocities of the fluid I and the fluid II on the basis of physical property values of the fluid I and the fluid II and the sizes of said first and second pipes such that the fluid II exhausted from said one end of said second pipe becomes fine particles surrounded by the fluid I within said first pipe;
wherein said flow velocity control means controls the flow velocities of the fluid I and the fluid II so as to satisfy the following formula (2),
$${D}^{2} = {D}_{ii}^{2} + \frac{4 / π}{\frac{1}{2} {C}_{D} ρ {U}_{e}^{2}} [ π γ {D}_{ii} - {ρ}^{′} π \frac{{D}_{ii}^{2}}{4} {U}_{i}^{2} ] \qquad ( 2 )$$
γ: interfacial tension coefficient (N/m),
D: diameter (m) of the fine particle,
ρ: density (kg/m³) of the fluid I,
ρ′: density (kg/m³) of the fluid II,
Uᵢ: average flow velocity (m/s) of the fluid II,
Uₑ: average flow velocity (m/s) of the fluid I around the fine particles,
Dᵢᵢ: inner diameter of the second pipe, and
C_{D}: flow resistance coefficient of the fine particles,
$${C}_{D} = \frac{κ}{Re} = \frac{κ}{{U}_{e} D {ρ}^{′}} μ$$
(Re: Reynolds number, κ: constant, μ: viscosity coefficient of the fluid I).

15. The producing apparatus of fine particles according to claim 13, wherein a flow path for flowing fluid α into said first pipe is provided in said first pipe at a region existing in the downstream direction from said one end of said second pipe.

16. The producing apparatus of fine particles according to claim 13, wherein said first and second pipes are pipes constructed by one of a metal, glass and resin.

17. A producing apparatus of fine particles comprising:
a first pipe for flowing fluid I therethrough;
a second pipe for flowing fluid II therethrough and arranged such that one end of the second pipe exists within said first pipe and the vicinity of said one end is extended substantially in parallel with the axial direction of said first pipe;
a third pipe for flowing fluid III therethrough and arranged such that one end of the third pipe exists within said second pipe and the vicinity of said one end of the third pipe is extended substantially in parallel with the axial direction of said second pipe; and
flow velocity control means for controlling the flow velocities of the fluid I, the fluid II and the fluid III on the basis of physical property values of the fluid I, the fluid II and the fluid III, and the sizes of said first, second and third pipes such that the fluid III exhausted from said one end of said third pipe becomes fine particles surrounded by the fluid II within said second pipe, and the fluid II exhausted from said one end of said second pipe becomes fine particles of a double structure surrounding one or more fine particles of the fluid III within said first pipe.

18. A producing apparatus of fine particles comprising:
n-pipes (n: a natural number of 3 or more) coaxially arranged with respect to each other such that one end of an n-th pipe for flowing an n-th fluid therethrough exists within an (n−1)-th pipe arranged outside the n-th pipe, and the vicinity of said one end of the n-th pipe is extended substantially in parallel with the axial direction of said (n−1)-th pipe; and
flow velocity control means for controlling the flow velocities of m-th, (m+1)-th and (m+2)-th fluids when m is any value of natural numbers of n−2 or less, on the basis of physical property values of the m-th, (m+1)-th and (m+2)-th fluids and the sizes of said m-th, (m+1)-th and (m+2)-th pipes such that the fine particles of the (m+1)-th fluid surrounding one or more fine particles of the (m+2)-th fluid exhausted from one end of the (m+2)-th pipe are exhausted from one end of the m-th pipe.
